(19) United States
(12) Patent Application Publication
(10) Pub. No.: US 2024/0290533 A1
(43) Pub. Date: Aug. 29, 2024

(54) IMPROVED PASSIVE DEVICE, ARRANGEMENT AND ELECTRIC CIRCUIT FOR LIMITING OR REDUCING A CURRENT RISE

(71) Applicant: Eaton Intelligent Power Limited, Dublin 4 (IE)

(72) Inventor: Petr KOPEJTKO, Prague (CZ)

(21) Appl. No.: 18/567,271

(22) PCT Filed: Jun. 10, 2022
(86) PCT No.: PCT/EP2022/025269

§ 371 Date: Dec. 5, 2023

(30) Foreign Application Priority Data
Jun. 10, 2021 (GB) 2108344.9

(51) Int. Cl. H01F 27/26; H01F 27/30

(52) U.S. Cl. CPC H01F 27/26; H01F 27/306

(57) ABSTRACT

A device for limiting or reducing a current rise is disclosed, which comprises a first magnetic core with at least one annular path for a magnetic flux, a first magnet arrangement having at least one permanent magnet in the at least one annular path of the first magnetic core and a first coil being wound around the first magnetic core. The at least one annular path has a first section with parallel sub paths, wherein a first sub path of the sub paths comprises a first bypass air gap and a second sub path of the sub paths is a continuous path comprising said first magnet arrangement. Further on, an arrangement with such a device and an electric circuit with such an arrangement is disclosed.

### TECHNICAL FIELD

The invention relates to a device for limiting or reducing a current rise, an arrangement with such a device and a switching device as well as an electric circuit with such an arrangement, which is connected to a DC grid.

### BACKGROUND ART

Generally, high currents running over switching contacts of a switching device are a problem in case of a switch off operation because the switching contacts are exposed to a switching arc, which is more intense the higher the current is. This is especially true in case of a short circuit or arc flash in the circuit downstream of the switching device. Such a short circuit or arc flash causes a very steep rise of the current flowing over the switching device, and it is very important that the switching device cuts off the short circuit or arc flash from the grid as fast as possible. However, naturally a finite time span is needed from the point in time when an overcurrent situation is detected until the point in time when the switching contacts of a switching device indeed are open and indeed are open wide enough to mitigate a switching arc burning between said switching contacts. This is equally true for electronic switches like solid state circuit breakers (SSCB) or hybrid solutions like hybrid circuit breakers (HCB). A low current rise (low di/dt) is important here because the semiconductors responsible for interrupting the current have a limited maximum switch off current. If the short circuit current raises above this limit, the switch is not able cut off the current.

Inductances in the electric circuit can limit said current rise. However, that does not properly work in DC grids because a magnetic core of the inductances tends to be saturated by the DC voltage what limits the effect of reducing the current rise in an overcurrent event. The reason is that the relative permeability does not only depend on the material of the magnetic core, but also on the magnetic flux density in said core. At high magnetic flux densities, the relative permeability μr can go down to 1. Air coils do not have that problem, but they are very large and hence unusable in many applications. For this reason, also permanent magnets have been proposed which generate a magnetic field in opposite direction of the magnetic field caused by a current. So, the magnetic core is biased with the permanent magnet so that the range, which is usable for the magnetic field caused by said current before the magnetic core gets saturated, is enlarged. However, these configurations suffer from the problem that very high currents can generate a magnetic field, which is so high that it demagnetizes the permanent magnet and hence destroy the current limiting device.

U.S. Pat. No. 5,821,844 A discloses a D.C. reactor with a core structure having two opposed cores separated by a magnetic gap, to form a closed magnetic circuit. A coil is wound on one or both of the cores. A pair of permanent magnets for biasing are disposed on the core structure. The bias flux generated by the permanent magnets and the flux generated by the coil to flow in opposite directions. Bypass means for causing the bias flux generated by the permanent magnets to bypass the magnetic gap are provided.

JP 2003 318046 A discloses a DC reactor, the main yoke of the DC reactor constituted by vertically combining an E-shaped laminated core with an I-shaped laminated core and a coil wound around the center leg of the core. On the other hand, protruded auxiliary yokes and are formed in the main yoke on both sides of the main magnetic gap of the main yoke in the vertical direction and, in addition, the permanent magnet is provided between the auxiliary yokes and so that a magnetic gap may be secured between the magnet and the main yoke.

JP 2007 281204 A discloses a DC reactor comprising a core structure forming a closed magnetic circuit where a plurality of cores are provided opposed with each other via a predetermined magnetic gap, a coil wound around this core structure, and a bias magnetic circuit including a permanent magnet provided to the core structure.

CN 106 057 395 A discloses a permanent magnet biased magnetic element assembly which comprises a first group of magnetic circuits, a second group of magnetic circuits, excitation coils and at least one permanent magnet connecting magnetic circuit.

### DISCLOSURE OF INVENTION

Accordingly, an object of the invention is the provision of an improved device for limiting or reducing a current rise, an improved arrangement with such a device and an improved electric circuit with such an arrangement. In particular, a solution shall be proposed, which allows to limit the deterioration of the switching contacts of a switching device in DC grids by use of simple and small sized means.

The object of the invention is solved by a device for limiting or reducing a current rise, comprising
a first magnetic core with at least one annular path for a magnetic flux,
a first magnet arrangement having at least one permanent magnet in the at least one annular path of the first magnetic core and
a first coil being wound around the first magnetic core, wherein
the at least one annular path has a first section with parallel sub paths and wherein a first sub path of the sub paths comprises a first bypass air gap and a second sub path of the sub paths is a continuous path comprising said first magnet arrangement.

Moreover, the object of the invention is solved by an arrangement, comprising the proposed device of the above kind and a switching device being switched in series with the first coil or a coil arrangement of said device having said first coil.

In addition, the object of the invention is solved by an electric circuit with an arrangement of the above kind being connected to a DC grid.

Finally, the object of the invention is solved by a use of a device of the above kind, which is switched in series with the first coil or a coil arrangement of said device having said first coil, in particular in a DC application.

On the one hand, the proposed device provides the function of biasing the magnetic core by the permanent magnet thus enlarging the range, which is usable for the magnetic field caused by said current before the magnetic core gets saturated. However, this just works for that direction of the current, which causes a magnetic field opposite to the magnetic field generated by the permanent magnet. So, saturation of the magnetic core during normal operation is effectively avoided or at least reduced. Accordingly, the magnetic core does substantially contribute to the inductance of the first coil over a wide current range and the inductance is not deteriorated by a saturated magnetic core. Hence, a rise of the current in case of a short circuit or an arc flash is effectively limited or reduced based on the inductance of the first coil and the annular magnetic core. Nonetheless, it should be noted that preferably the magnetic core is designed in a way that saturation does also not occur during an overcurrent event. This may be achieved by a proper design of the bypass airgap which also influences the point from where magnetic saturation occurs.

That means that the switch off current at the time when the switching contacts of a switching device indeed are open and indeed are open wide enough to mitigate a switching arc burning between said switching contacts is substantially reduced compared to prior art solutions. The proposed device is particularly usable in DC grids and effectively reduces deterioration of the switching contacts of a switching device there. At the same time it is small sized and thus particularly usable in applications with limited space. The proposed device is also particularly useful for “slow” switching devices where comparably much time is needed from the detection of an overcurrent situation until the switching contacts of a switching device indeed are opened.

The first magnet arrangement preferably is designed in way, that its magnetic field does not saturate the first magnetic core either. However, the first magnet arrangement may even be so strong that the first magnetic core gets saturated. That means that in the first moment of an overcurrent situation, the first coil basically acts as an air coil and then over time the first magnetic core gets effective. This embodiment can be useful in applications where the first magnetic core shall be comparably small, and the first magnet arrangement shall ensure that the full non-saturated range of first magnetic core is utilized.

Because the proposed device limits or reduces a current rise, it could also be seen and termed as “current rise limiter”.

On the other hand, the bypass air gap takes over a part of the magnetic flux (or even the main part) particularly in case of excessive current. So, the part of the magnetic flux running through the permanent magnet can be kept small. In particular, said current caused magnetic flux through the permanent magnet shall be so low that it does not cause demagnetization of the permanent magnet. Hence, the bypass air gap protects the proposed device from being destroyed by excessive current.

Concluding, the proposed device provides both a biasing function and an overcurrent protection at small size, with low weight, lower conduction losses (due to the shorter length of the conductor of the first coil) and lower electromagnetic emission in particular compared to air coils.

Generally, the switching device can be embodied as vacuum interrupter. Vacuum interrupters can switch very fast because the dielectric distance, which is necessary to avoid an arc between the switching contacts, is very short. So, the reduced current rise in case of a short circuit or an arc flash can be utilized in an advantageous way.

Generally, the switching device may react on an overcurrent. In such a case, it fulfills the function of a circuit breaker and may be termed accordingly throughout this disclosure. In particular, such a circuit breaker can be embodied as a solid state circuit breaker (SSCB) or a hybrid circuit breaker (HCB). More particularly, the mechanical switching part of such a hybrid circuit breaker may be embodied as a vacuum interrupter providing the advantages which have already disclosed above.

Generally, the basic embodiment of the proposed device is usable in DC applications, where the current direction does not reverse or where a reversed current cannot exceed a particular limit (e.g. because of an inner resistance of a voltage source). If the limit in the reversed current direction is low enough that a switching device (e.g. a circuit breaker) can cut off the current without problems, a unidirectional current limiting or reducing device can be sufficient. However, bidirectional designs are possible as well and explained hereinafter.

In an advantageous embodiment, the first magnetic core has a first annular path for a magnetic flux, in which the first magnet arrangement and the first section with parallel sub paths is arranged, and the device additionally comprises
a separate second magnetic core with a second annular path for a magnetic flux,
a second magnet arrangement having at least one permanent magnet in the second annular path of the second magnetic core,
a second coil being wound around the second magnetic core and
a second section in the second annular path with parallel sub paths, wherein a first sub path of the sub paths comprises a second bypass air gap and a second sub path of the sub paths is a continuous path comprising said second magnet arrangement and wherein
the first coil and the second coil are switched in series and form a coil arrangement and wherein
the first magnet arrangement and a current through the coil arrangement in the first coil cause magnetic fluxes in different rotational senses within the first magnetic core, and the second magnet arrangement and the current through the coil arrangement in the second coil cause magnetic fluxes in the same rotational sense within the second magnetic core.

This embodiment provides bidirectional function by doubling the proposed device and by connecting the first and the second coil accordingly. So, in one current direction, the first magnetic core is active, meaning that the magnetic field of the first magnet arrangement is oriented opposite to the magnetic field of the first coil, and in the other current direction, the second magnetic core is active, meaning that the magnetic field of the second magnet arrangement is oriented opposite to the magnetic field of the second coil. So, this embodiment is particularly usable in DC applications, where the current direction can reverse at high currents. Both sub devices of the proposed device preferably are designed identically. However, they may also be designed differently as the case may be.

It is also advantageous if the first magnetic core has two interconnected annular paths for a magnetic flux formed by three legs and interconnections of first ends of the three legs and interconnections of second ends of the legs, wherein
a first leg of the legs comprises the first section with the parallel sub paths, wherein
a second leg of the legs comprises a second section with parallel sub paths, wherein a first sub path of the sub paths comprises a second bypass air gap and a second sub path of the sub paths is a continuous path comprising a second magnet arrangement having at least one permanent magnet, wherein
the first coil is wound around the third leg and wherein
the first magnet arrangement and the second magnet arrangement cause a magnetic flux in the same rotational sense.

This is another embodiment providing bidirectional function, but with a single magnetic core and a single coil. In one current direction, a first annular path is active, meaning that the magnetic field of the first magnet arrangement is oriented opposite to the magnetic field of the first coil, and in the other current direction, the second path is active, meaning that the magnetic field of the second magnet arrangement is oriented opposite to the magnetic field of the first coil. So, this embodiment is particularly usable in DC applications, where the current direction can reverse at high currents, too.

Further advantageous embodiments are disclosed in the claims and in the description as well as in the figures.

Beneficially,
in the first section the first sub path is straight, and the second sub path dodges the first sub path and/or
in the second section the first sub path is straight and the second sub path dodges the first sub path.

In this way, the first sub paths can easily be made short in relation to the second sub paths what in turn helps to make the magnetic resistance of the first sub paths considerably lower than the magnetic resistance of the second sub paths. If so, the first sub paths take over the main part of the magnetic flux in case of excessive current. So, the part of the magnetic flux running through the permanent magnet can be kept small and a risk for a demagnetization of the permanent magnet can be avoided or at least reduced.

Further on, it is beneficial if
in the first section the second sub path comprises a first part being arranged perpendicular to the first straight sub path, a second part adjacent to the first part being arranged parallel to the first straight sub path and a third part adjacent to the second part being arranged perpendicular to the first straight sub path and/or
in the second section the second sub path comprises a first part being arranged perpendicular to the first straight sub path, a second part adjacent to the first part being arranged parallel to the first straight sub path and a third part adjacent to the second part being arranged perpendicular to the first straight sub path. In this way, the second sub paths comprise path segments, which form corners at their connections. Accordingly, the second sub paths can be built up by cuboid parts being strung together.

Advantageously,
in the first section each of the three parts consists of a permanent magnet and/or
in the second section each of the three parts consists of a permanent magnet. In this way, a comparably high magnetic field can be generated by the first and/or second magnet arrangement, in particular by chaining cuboid permanent magnets. Moreover, this solution provides a comparably high magnetic resistance for the magnetic flux generated by the first and/or second coil in the second sub paths. This is based on the fact that permanent magnets form a comparably high magnetic resistance for outer magnetic fields. Basically, the permeability of permanent magnets is close to that of air. In turn, the magnetic flux generated by the first and/or second coil tends to flow over the bypass airgaps thus protecting the permanent magnet from demagnetization. However, the length of the bypass airgaps shall be chosen under consideration of the total length of the permanent magnets.

Alternatively
in the first section the first part and the third part each can consist of a permanent magnet and the second part can be part of the first magnetic core and/or
in the second section the first part and the third part each can consist of a permanent magnet and the second part can be part of the second magnetic core. Here two of three parts are permanent magnets (preferably of the same shape) causing a permanent magnetic flux. The magnetic resistance usually is a bit smaller than if all three parts would form magnets. Again, the length of the bypass airgaps shall be chosen under consideration of the total length of the permanent magnets.

In another alternative embodiment
in the first section the first part and the third part each can be part of the first magnetic core and the second part can consist of a permanent magnet and/or
in the second section the first part and the third part each can be part of the second magnetic core and the second part can consist of a permanent magnet. Here just one of three parts is a permanent magnet causing a permanent magnetic flux. The magnetic resistance usually is even smaller than for the embodiment mentioned before. Again, the length of the bypass airgaps shall be chosen under consideration of the total length of the permanent magnets.

Generally, it is of advantage if
a length of the first bypass air gap is smaller than a total length of parts in the first section consisting of a permanent magnet each measured in a direction of the magnetic flux and/or
a length of the second bypass air gap is smaller than a total length of parts in the second section consisting of a permanent magnet each measured in a direction of the magnetic flux.

By these measures, it is ensured that the magnetic resistance in the first sub path (which is basically defined by the first bypass air gap) is smaller than the magnetic resistance in second sub path (which is basically defined by the total length of the permanent magnets). This relation is based on the fact that permanent magnets form a comparably high magnetic resistance for outer magnetic fields (near to those of an air gap). In turn, the magnetic flux generated by the first and/or second coil tends to flow over the bypass airgaps thus avoiding demagnetization of the permanent magnets in case of excessive currents.

Advantageously, the first magnetic core and/or the second magnetic core comprises a main air gap, which in case that the first magnetic core has two interconnected annular paths is arranged in the third leg of the legs. In this way, the current level at which the first and/or the magnetic core saturates, can be influenced.

It is particularly advantageous if the first magnetic core and/or the second magnetic core adjacent to the main air gap comprises a stepping or a tapering (i.e. is stepped or tapered and in particular is shaped like a truncated pyramid or shaped like a truncated cone). Accordingly, the first magnetic core and/or the second magnetic core in the region of the main air gap comprises a thin section, in which the cross section of the first magnetic core and/or the second magnetic core is reduced compared to sections of the first magnetic core and/or the second magnetic core, which are farer away from the main air gap.

The first magnetic core and/or the second magnetic core preferably is designed in a way that its thin section is not saturated if the current through the first and/or second coil is under a nominal value of said device. Said nominal value marks the normal operating region of the proposed device and may be printed on it directly as a current value or may be associated with a code printed on the proposed device. If the current exceeds the nominal current, the thin section of the first magnetic core and/or the second magnetic core saturates and behaves like it had a much bigger air gap there. The reason is that the saturated thin section behaves like an air gap. So, the effective length of the main air gap is greater than its geometric length in this operational state.

Advantageously, the first coil and/or the second coil is arranged in the region of the main air gap. Because of the fringing effect, the magnetic flux in the air gap tends to bulge out. Accordingly, flux lines do cross the conductor of the first coil and/or the second coil and induce eddy currents there what in turn increases the resistance of the first coil and/or the second coil. So, this is a further measure to limit or reduce a current rise.

Beneficially,
the permanent magnet or permanent magnets of the first magnet arrangement and/or the second magnet arrangement is/are made of Neodymium and/or
the first magnetic core and/or the second magnetic core is made of soft iron or Vanadium permendur.

Neodymium magnets (actually an alloy, namely Nd₂Fe₁₄B) are very strong permanent magnets and hence provide a very good biasing function in the proposed device at a small size. Vanadium permendur is a soft ferromagnetic alloy comprising cobalt (Co), iron (Fe) and vanadium (Va) and in particular has a saturation flux of more than 2 Tesla. Hence, the cross section of the first and/or second magnetic core can be kept small, allowing for small sized devices of the proposed kind as well. However, generally the material of the first and/or second magnetic core and its cross section should be designed in a way that the magnetic flux up to a nominal current through the first and/or second coil can be handled without or just low saturation.

Finally, it is of advantage if a single device of the proposed kind is switched in series with a plurality of switching devices. In this way, a single device of the proposed kind can be used to limit a current rise in a plurality of switching devices. Such an embodiment can be seen as a single arrangement with a plurality of outputs or, in particular if the device of the proposed kind and the plurality of switching devices are distributed over a larger area, as an electric circuit having said features.

For the sake of completeness it is noted that the various embodiments disclosed in the context of the first magnetic core and its characteristics and advantageous resulting thereof equally apply to the second magnetic core.

It should be noted that the various embodiments and the advantages resulting thereof which have been presented for the proposed device, the arrangement or the electric circuit are interchangeable as the case may be. That means, that an embodiment or advantage, which has been presented for the proposed device may equally apply to the arrangement and so on.

### BRIEF DESCRIPTION OF DRAWINGS

The invention now is described in more detail hereinafter with reference to particular embodiments, which the invention however is not limited to.

FIG. 1 shows a schematic view of a proposed device for limiting or reducing a current rise;

FIG. 2 shows a schematic view of a first magnetic core with a tapered main air gap;

FIG. 3 shows a schematic view of a first magnetic core without a main air gap;

FIG. 4 shows an example where the first magnet arrangement comprises three permanent magnets;

FIG. 5 shows an example where the first magnet arrangement comprises two permanent magnets;

FIG. 6 shows an example where the first magnet arrangement comprises one permanent magnet;

FIG. 7 shows a device providing bidirectional current limiting or reducing with two magnetic cores;

FIG. 8 shows a device providing bidirectional current limiting or reducing with a single magnetic core;

FIG. 9 shows an arrangement with a device of the proposed kind and a switching device being switched in series with the first coil;

FIG. 10 shows an example where a single device of the proposed kind is switched in series with a plurality of switching devices and

FIGS. 11 to 14 show the first magnetic core in different operating states.

### DETAILED DESCRIPTION

Generally, same parts or similar parts are denoted with the same/similar names and reference signs. The features disclosed in the description apply to parts with the same/similar names respectively reference signs. Indicating the orientation and relative position is related to the associated figure, and indication of the orientation and/or relative position has to be amended in different figures accordingly as the case may be.

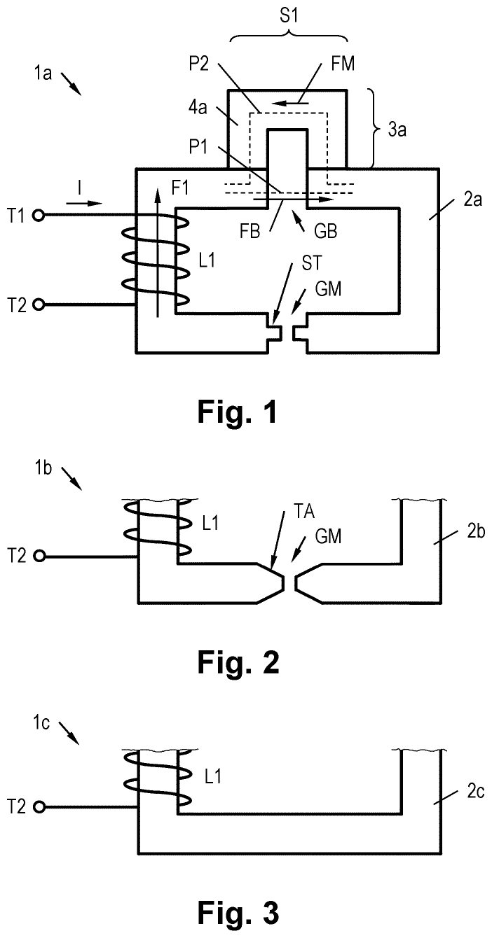

FIG. 1 shows a device 1a for limiting or reducing a current rise, which comprises a first magnetic core 2a with an annular path for a magnetic flux F1, FM, FB, a first magnet arrangement 3a having a permanent magnet 4a in the annular path of the first magnetic core 2a and a first coil L1 being wound around the first magnetic core 2a, wherein ends of the first coil L1 are electrically connected to terminals T1, T2 of the device 1a. The annular path has a first section S1 with parallel sub paths P1, P2, wherein a first sub path P1 of the sub paths P1, P2 comprises a first bypass air gap GB and a second sub path P2 of the sub paths P1, P2 is a continuous path comprising said first magnet arrangement 3a.

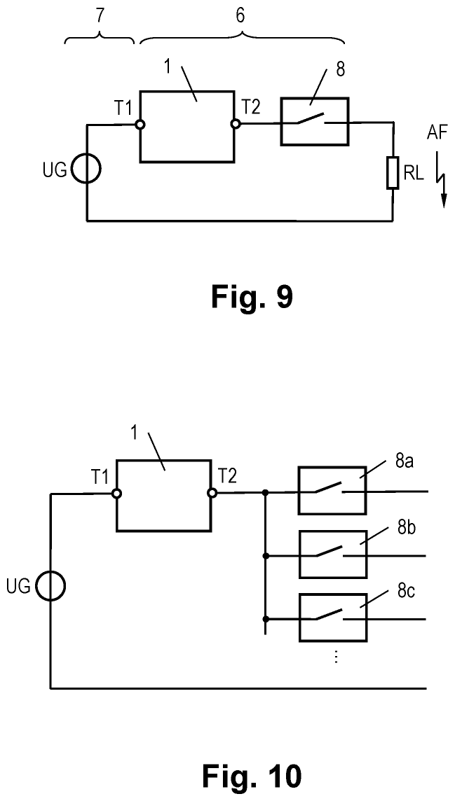

If no current I flows through the first coil L1, there is just the magnetic flux FM generated by the permanent magnet 4a which in the given example has a counterclockwise rotational sense. A current I through the first coil L1 generates a magnetic flux F1, which is oriented opposite to the magnetic flux FM generated by the permanent magnet 4a. So, depending on the strength of the magnetic fields generated by the first coil L1 and the permanent magnet 4a there is a total magnetic flux flowing through the first magnetic core 2a in counterclockwise direction (F1<FM) or in clockwise direction (F1>FM). So, the permanent magnet 4a biases the first magnetic core 2a and in turn the usable range for the magnetic flux F1 generated by the first coil L1 before the first magnetic core 2a gets saturated is increased. Accordingly, the first magnetic core 2a does substantially contribute to the inductance of the first coil L1 over a wide current range and the inductance is not deteriorated by saturation. Hence, a rise of the current in case of a short circuit or an arc flash is effectively limited or reduced based on the inductance of the first coil L1 and the first magnetic core 2a. That means that the switch off current at the time when the switching contacts of a switching device (see FIGS. 9 and 10) indeed are open and indeed are open wide enough to mitigate a switching arc burning between said switching contacts is substantially reduced compared to prior art solutions.

Now, the role of the bypass air gap GB is explained. Because first section S1 has parallel sub paths P1, P2, the magnetic flux F can take either way. So, there is a certain amount of the magnetic flux F1 caused by the first coil L1 which flows over the over the first sub path P1 and hence over the bypass air gap GB. In detail, this amount is denoted as the magnetic flux FB. The other part (F1-FB) flows over the second sub path P2. Concretely, the magnetic flux F1 is split according to the magnetic resistance of the first sub path P1 and the second sub path P2. So, by a proper design of the first magnetic core 2a, the amount of the magnetic flux F1, which flows over the over the second sub path P2, shall be kept below a level causing demagnetization of the permanent magnet 4a in case of excessive current I.

Concluding, the proposed device 1a provides both a biasing function and an overcurrent protection. Hence, the proposed device 1a is robust and also small sized compared to known solutions, in particular over air coils.

To achieve the protection function, preferably, the first sub path P1 is straight and the second sub path P2 dodges the first sub path P1. In this way, the first sub path P1 can easily be made short in relation to the second sub path P2 what helps to make the magnetic resistance of the first sub path P1 lower than the magnetic resistance of the second sub path P2.

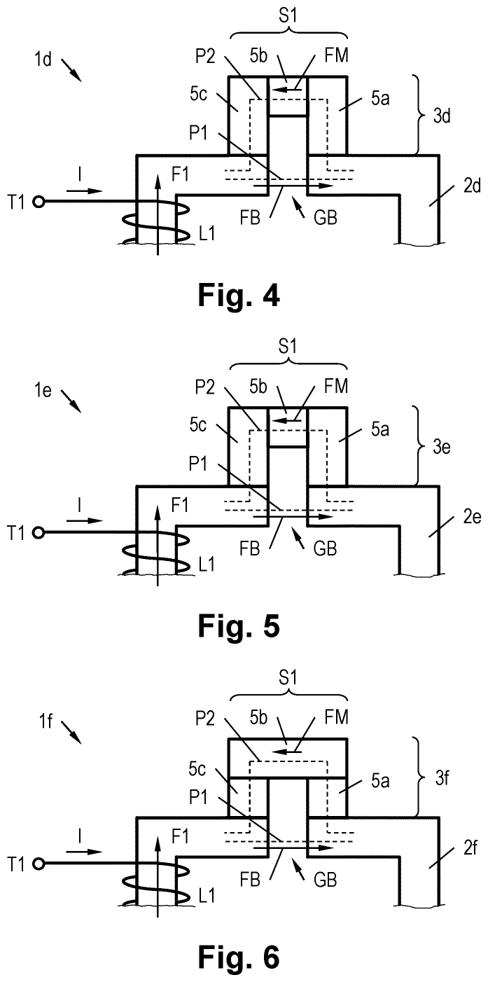

Generally, it is of advantage if a length of the first bypass air gap GB is smaller than a total length of parts in the second sub path P2 consisting of a permanent magnet 4a, each measured in a direction of the magnetic flux FM, FB. In the example of FIG. 1, the whole second sub path P2 is formed by a single U-shaped permanent magnet 4a (however, this is not the only possibility and other possibilities are applicable as well-see FIGS. 4 to 6 for example). So said total length in the second sub path P2 is the length of the permanent magnet 4a along the dashed line, basically between the crossing points with the center line of the first sub path P1 (note that said center line is drawn outwards of the real center so as to clearly distinguish both dashed lines). By these measures, it is ensured that the magnetic resistance in the first sub path P1 (which is basically defined by the length of the first bypass air gap GB) is smaller than the magnetic resistance in second sub path P1 (which is basically defined by the total length of the permanent magnet 4a). This relation is based on the fact that permanent magnets form a comparably high magnetic resistance for outer magnetic fields (near to those of an air gap).

In this example, the first magnetic core 2a comprises an optional main air gap GM. This is another possibility to influence the saturation point of the first magnetic core 2a. It is particularly advantageous if magnetic core 2a adjacent to the main air gap GM comprises a stepping ST, i.e. is stepped. Accordingly, the first magnetic core 2a in the region of the main air gap GM comprises a thin section, in which the cross section of the first magnetic core 2a is reduced compared to sections of the first magnetic core 2a, which are farer away from the main air gap GM. The first magnetic core 2a preferably is designed in a way that its thin section is not saturated if the current I through the first coil L1 is under a nominal value of said device 1a. If the current exceeds the nominal current I, the thin section of the first magnetic core 2a saturates and the device 1a behaves like it had a much bigger main air gap GM there. The reason is that the saturated thin section behaves like an air gap in this operational state. So, the effective length of the main air gap GM is greater than its geometric length in said operational state. Accordingly, the graph of the current I over the magnetic resistance first magnetic core 2a and thus an inductance of the first coil L1 may be influenced in a way that it comprises a kind of a step. So, there are different current ranges with different behavior of the inductance of the first coil L1.

In the example depicted in FIG. 1, the first coil L1 is arranged in region where the first magnetic core 2a is continuous (i.e. where it has no gap). However, it is also advantageous if the first coil L1 is arranged in the region of the main air gap GM. Because of the fringing effect, the magnetic flux L1 in the main air gap GM tends to bulge out. Accordingly, flux lines cross the conductor of the first coil L1 and induce eddy currents there what in turn increases the resistance of the first coil L1. So, this is a further measure to limit or reduce a current rise.

A stepping ST is not the only way to influence the graph of the current I over the magnetic resistance of the first magnetic core 2a or the inductance of the first coil L1. The first magnetic core 2a adjacent to the main air gap GM can also comprise a tapering TA for the same reason as this is depicted for the device 1b in FIG. 2. In particular, the ends of the first magnetic core 2a can be shaped like a truncated pyramid or shaped like a truncated cone.

Alternatively, a main air gap GM may also be omitted as this is depicted for the device 1c in FIG. 3.

FIGS. 4 to 6 show various designs of the second sub path P2. In all of the shown embodiments the second sub path P2 comprises a first part 5a being arranged perpendicular to the first straight sub path P1, a second part 5b adjacent to the first part 5a being arranged parallel to the first straight sub path P1 and a third part 5c adjacent to the second part 5b being arranged perpendicular to the first straight sub path P1. In this way, the second sub path P2 comprises segments, which form corners at their connections. Accordingly, the second sub path P2 can be built up by cuboid parts 5a . . . 5c being strung together.

FIG. 4 shows an embodiment of a device 1d, where each of the three parts 5a . . . 5c consists of a permanent magnet 4a. So, from a functional viewpoint, this embodiment corresponds to that of FIG. 1 because of the corresponding total form of the permanent magnet(s) 4a. The only difference is that the second sub path P2 is built up by cuboid parts 5a . . . 5c being strung together.

FIG. 5 shows a device 1e, where the first part 5a and the third part 5c each consists of a permanent magnet 4a and the second part 5b is part of the first magnetic core 2a. Here two of the three parts 5a . . . 5c are permanent magnets 4a (preferably of the same shape) causing a permanent magnetic flux FM. The magnetic resistance usually is a bit smaller than if all three parts 5a . . . 5c would form magnets 4a, and the length of the bypass airgap GB shall be chosen under consideration of the total length of the first part 5a and the third part 5c.

FIG. 6 shows a device 1f, where the first part 5a and the third part 5c each is part of the first magnetic core 2a and the second part 5b consists of a permanent magnet 4a. Here just one of the three parts 5a . . . 5c is a permanent magnet 4a causing a permanent magnetic flux FM. The magnetic resistance usually is even smaller than for the embodiment of FIG. 5. Accordingly, the length of the bypass airgap GB shall be chosen under consideration of the total length of the second part 5b.

Generally, the basic embodiment of the proposed device 1a depicted in FIG. 1 is usable in DC applications, where the current direction does not reverse or where a reversed current cannot exceed a particular limit (e.g. because of an inner resistance of a voltage source). If the limit in the reversed current direction is low enough that a switching device (e.g. a circuit breaker) can cut off the current I without problems, the unidirectional current limiting or reducing device 1a can be sufficient.

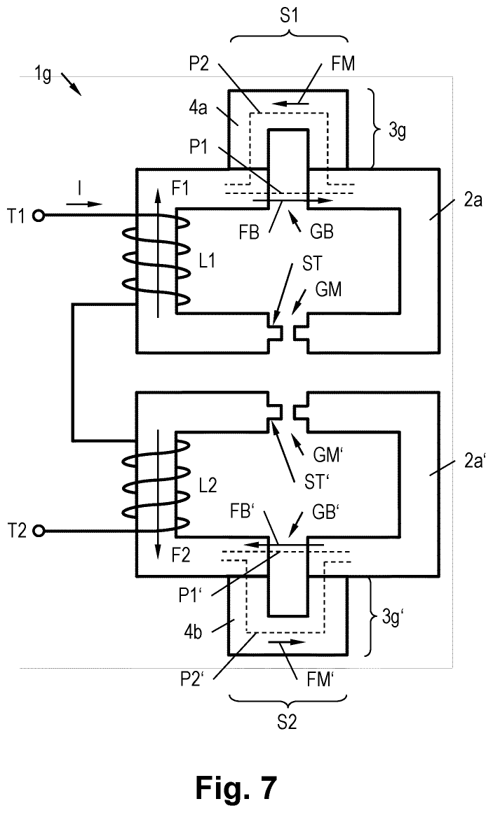

However, FIG. 7 shows a device 1g, where the device 1a of FIG. 1 is doubled and a first coil L1 and second coil L2 are connected accordingly. In detail, the first magnetic core 2a has a first annular path for a magnetic flux F1, FM, FB, in which the first magnet arrangement 3a and the first section S1 with parallel sub paths P1, P2 is arranged, as already outlined hereinbefore. In addition, the device 1g comprises a separate second magnetic core 2a′ with a second annular path for a magnetic flux F2, FM′, FB′,
a second magnet arrangement 3g′ having at least one permanent magnet 4b in the second annular path of the second magnetic core 2a′,
a second coil L2 being wound around the second magnetic core 2a′ and
a second section S2 in the second annular path with parallel sub paths P1′, P2′, wherein a first sub path P1′ of the sub paths P1′, P2′ comprises a second bypass air gap GB′ and a second sub path P2′ of the sub paths P1′, P2′ is a continuous path comprising said second magnet arrangement 3g′, wherein
the first coil L1 and the second coil L2 are switched in series and form a coil arrangement and wherein
the first magnet arrangement 3a . . . 3h and a current I through the coil arrangement in the first coil L1 cause magnetic fluxes F1, FM in different rotational senses within the first magnetic core 2a . . . 2h and the second magnet arrangement 3g′ and the current I through the coil arrangement in the second coil L2 cause magnetic fluxes F2, FM′ in the same rotational sense within the second magnetic core 2a′.

So, in one current direction, the first magnetic core 2a is active, meaning that the magnetic field of the first magnet arrangement 3g is oriented opposite to the magnetic field of the first coil L1, and in the other current direction, the second magnetic core 2a′ is active, meaning that the magnetic field of the second magnet arrangement 3g′ is oriented opposite to the magnetic field of the second coil L2. In detail, the first magnetic core 2a is active for the current direction depicted in FIG. 7, and the second magnetic core 2a′ is active for the opposite current direction.

For the sake of completeness it is noted that the various embodiments disclosed in the context of the FIGS. 1 to 6 equally apply to the device 1e of FIG. 7. In particular this means that the various embodiments of the first magnetic core of FIGS. 1 to 6 and the arrangement of the first coil L1 in the region of the main air gap GM can be transferred to the second magnetic core 2a′ and the arrangement of the second coil L2. In FIG. 7, both sub devices of the device 1e are designed identically. However, they may also be designed differently as the case may be.

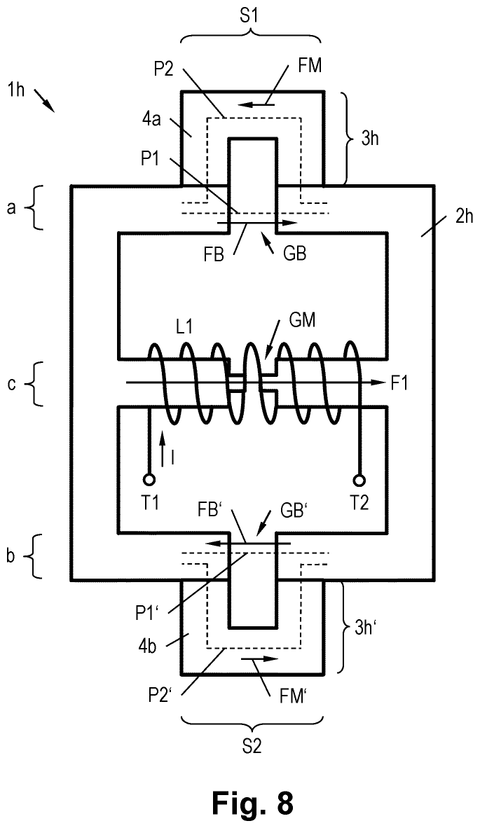

FIG. 8 shows another device 1h providing bidirectional current limiting or reducing but with a single first magnetic core 2h. In detail, the first magnetic core 2h has two interconnected annular paths for a magnetic flux F1, F2, FM, FM′, FB, FB′ formed by three legs a, b, c and interconnections of first ends of the three legs a, b, c and interconnections of second ends of the legs a, b, c, wherein
a first leg a of the legs a, b, c comprises the first section S1 with the parallel sub paths P1, P2, wherein
a second leg b of the legs a, b, c comprises a second section S2 with parallel sub paths P1′, P2′ and wherein a first sub path P1′ of the sub paths P1′, P2′ comprises a second bypass air gap GB′ and a second sub path P2′ of the sub paths P1′, P2′ is a continuous path comprising a second magnet arrangement 3h′ having at least one permanent magnet 4b, wherein
the first coil L1 is wound around the third leg c and wherein
the first magnet arrangement 3a . . . 3h and the second magnet arrangement 3h′ cause a magnetic flux FM, FM′ in the same rotational sense.

In one current direction, the upper part of the first magnetic core 2h is active, meaning that the magnetic field FM of the first magnet arrangement 3h is oriented opposite to the magnetic field F1 of the first coil L1, and in the other current direction, the lower part of the first magnetic core 2h is active, meaning that the magnetic field FM′ of the second magnet arrangement 3h′ is oriented opposite to the magnetic field F1 of the first coil L1. In detail, the lower part is active for the current direction depicted in FIG. 8, and the upper part is active for the opposite current direction.

For the sake of completeness it is noted that the various embodiments disclosed in the context of the FIGS. 1 to 6 equally apply to the device 1h of FIG. 8. In particular this means that the various embodiments of the first magnetic core of FIGS. 1 to 6 can be transferred to first magnetic core 2h of FIG. 8. In FIG. 8, the first coil L1 is arranged in the region of the main air gap GM providing the advantages which have already been outlined before. However, it is also possible to arrange the first coil L1 out of said region.

Preferably, the permanent magnet 4a, 4b or permanent magnets of the first magnet arrangement 3a . . . 3h and/or the second magnet arrangement 3g, 3g′ is/are made of Neodymium. Neodymium magnets are very strong permanent magnets and hence provide a very good biasing function in the proposed device 1a . . . 1h at a small size.

It is also preferred if the first magnetic core 2a . . . 2h and/or the second magnetic core 2a′ is made of soft iron or Vanadium permendur. Vanadium permendur is a soft ferromagnetic alloy having a saturation flux of more than 2 Tesla. Hence, the cross section of the first magnetic core 2a . . . 2h and/or the second magnetic core 2a′ can be kept small, allowing for small sized devices 1a . . . 1h of the proposed kind as well.

Generally, the first magnetic core 2a . . . 2h and/or the second magnetic core 2a′ should be designed in a way that it does not saturate or does not saturate just in parts up to a nominal current and preferably even not in case of an overcurrent event. This may be achieved by a proper design of the cross sections of the first magnetic core 2a . . . 2h and/or the second magnetic core 2a, of its bypass air gap(s) GB, GB′ and main air gap GM, GM′ and a proper material choice. The first magnet arrangement 3a . . . 3h and/or second magnet arrangement 3g′, 3h′ preferably is designed in way, that its magnetic field FM, FM′ does not saturate the first magnetic core 2a . . . 2h and/or the second magnetic core 2a′ either. However, the first magnet arrangement 3a . . . 3h and/or second magnet arrangement 3g′, 3h′ may even be so strong that the first magnetic core 2a . . . 2h and/or the second magnetic core 2a′ gets saturated. That means that in the first moment of an overcurrent situation, the first coil L1 and/or the second coil L2 basically acts as an air coil and then over time the first magnetic core 2a . . . 2h and/or the second magnetic core 2a′ gets effective. This embodiment can be useful in applications where the first magnetic core 2a . . . 2h and/or the second magnetic core 2a′ shall be comparably small, and the first magnet arrangement 3a . . . 3h and/or second magnet arrangement 3g′, 3h′ shall ensure that the full non-saturated range of first magnetic core 2a . . . 2h and/or the second magnetic core 2a′ is utilized.

FIG. 9 now shows an arrangement 6, comprising a device 1 of the kind presented hereinbefore and a switching device 8 being switched in series with the first coil L1 or—in case of an embodiment as depicted in FIG. 7—with the coil arrangement of said device 1. The arrangement 6 moreover is connected to a DC grid 7 with a grid voltage source UG and a load RL forming an electric circuit. Additionally, an arc flash AF is depicted in FIG. 9.

As already said, the device 1 limits or reduces a current rise in case that a short circuit or an arc flash AF occurs in the electric circuit formed by the arrangement 6, the DC grid 7 and the load RL. By the proposed measures, the range, which is usable for the magnetic flux F1, F2 caused by the current I before the first magnetic core 2a . . . 2h and/or the second magnetic core 2a′ gets saturated is enlarged. Accordingly, the first magnetic core 2a . . . 2h and/or the second magnetic core 2a′ does substantially contribute to the inductance of the first coil L1 and/or the second coil L2 over a wide current range and the inductance is not deteriorated by a saturated first magnetic core 2a . . . 2h and/or the second magnetic core 2a′. Hence, a rise of the current I in case of a short circuit or an arc flash AF is effectively limited or reduced based on the inductance of the first coil L1 and/or the second coil L2 and first magnetic core 2a . . . 2h and/or the second magnetic core 2a′

As generally known, a switching device 8 needs a certain time span from the point in time when an overcurrent situation is detected until the point in time when the switching contacts of the switching device 7 indeed are open and indeed are open wide enough to mitigate a switching arc burning between said switching contacts. By use of the proposed measures, the switch off current, which occurs at the end of said time span is substantially reduced compared to prior art solutions.

The proposed device 1 is particularly usable in DC grids 7 and effectively reduces a deterioration of the switching contacts of a switching device 8 there. At the same time it is small sized and thus particularly usable in applications with limited space. The proposed device 1 is also particularly useful for “slow” switching devices 8 where comparably much time is needed from the detection of an overcurrent situation until the switching contacts of the switching device 8 indeed are opened.

Generally, the switching device 8 can be embodied as vacuum interrupter. Vacuum interrupters can switch very fast because the dielectric distance, which is necessary to avoid an arc between the switching contacts, is very short. So, the reduced current rise in case of a short circuit or an arc flash AF can be utilized in an advantageous way.

Generally, the switching device 8 may react on an overcurrent. In such a case, it fulfills the function of a circuit breaker. In particular, such a circuit breaker can be embodied as a solid state circuit breaker or a hybrid circuit breaker. More particularly, the mechanical switching part of such a hybrid circuit breaker may be embodied as a vacuum interrupter providing the advantages which have already disclosed above.

FIG. 10 now shows an example where a single device 1 is switched in series with a plurality of switching devices 8a . . . 8c. Here, the device 1 is designed to limit a current rise for any of these switching devices 8a . . . 8c.

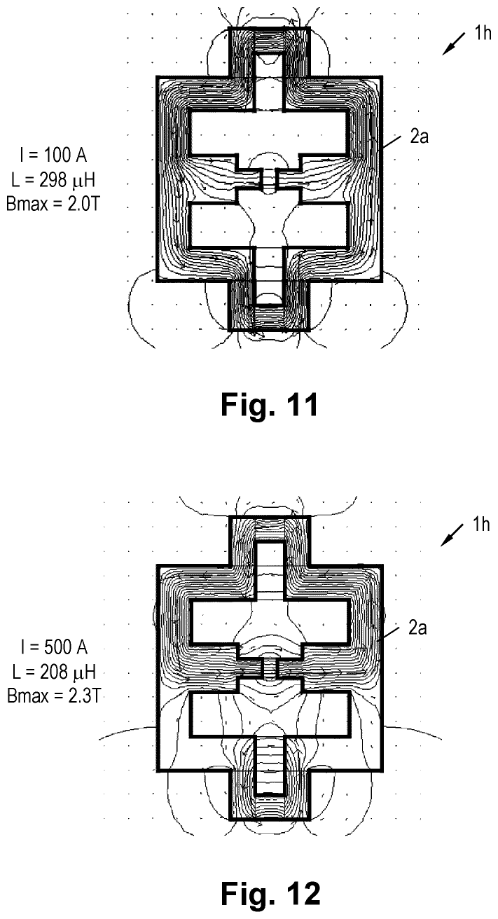

FIGS. 11 to 14 finally show the first magnetic core 2a of the device 1h in different operating states, which are indicated in the respective Fig. by the current I, the inductivity L and the maximum magnetic flux density Bmax. FIGS. 11 to 14 particularly show the magnetic flux within the first magnetic core 2a by flux lines, whose density indicate the density of the magnetic flux. Arrows indicate the direction of the magnetic flux. It should be noted the maximum magnetic flux density Bmax varies throughout

FIGS. 11 to 14. That means the same density of the flux lines does not mean the same magnetic flux density in FIGS. 11 to 14. Instead, the magnetic flux density associated with a particular density of the flux lines increases from FIGS. 11 to 14.

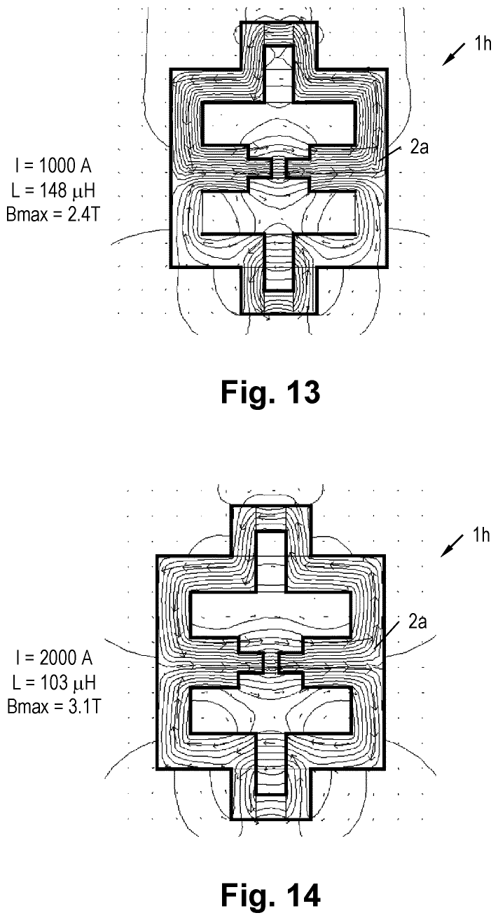

FIG. 11 shows a state at a comparably low current I. Accordingly, the distribution of the magnetic flux in the first magnetic core 2a is almost symmetric. In the state of FIG. 12, the magnetic flux F1 caused by the first coil L1 and the magnetic flux FM′ generated by the second magnet arrangement 3h′ is almost the same. So, there is almost no magnetic flux in parts of the second leg b of the first magnetic core 2a. In FIG. 13, the magnetic flux F1 caused by the first coil L1 exceeds the magnetic flux FM′ generated by the second magnet arrangement 3h′. So, the direction of the magnetic flux in parts of the first magnetic core 2a reverses. It is also visible, that a considerable amount of the magnetic flux runs over the bypass air gap GB′. In FIG. 14, the magnetic flux F1 caused by the first coil L1 is even higher. FIGS. 12 to 14 particularly show the fringing effect, i.e. bulging out of the magnetic flux lines in the region of the main air gap GM.

Three basic operation modes can be defined:

1. Both the first leg a and the second leg b are not saturated. In this mode the inductivity L is the highest.

2. One leg of the first leg a and the second leg b is saturated and the other one is not saturated. In this mode the inductivity L drops to approximately the half of its maximum.

3. Both the first leg a and the second leg b are saturated. In this mode the inductivity L basically corresponds to that of an air coil.

It is noted that the invention is not limited to the embodiments disclosed hereinbefore, but combinations of the different variants are possible. In reality, the device 1, 1a . . . 1h and the arrangement 6 may have more or less parts than shown in the figures. Moreover, the description may comprise subject matter of further independent inventions.

It should also be noted that the term “comprising” does not exclude other elements and the use of articles “a” or “an” does not exclude a plurality. Also elements described in association with different embodiments may be combined. It should also be noted that reference signs in the claims should not be construed as limiting the scope of the claims.

### LIST OF REFERENCE NUMERALS

1, 1a . . . 1h device
2a . . . 2h first magnetic core
2a′ second magnetic core
3a . . . 3h first magnet arrangement
3g′, 3h′ second magnet arrangement
4a, 4b permanent magnet
5a . . . 5c parts of second sub path
6 electric circuit
7 DC grid
8, 8a . . . 8c circuit breaker
a first leg of magnetic core (continuous)
b second leg of magnetic core (continuous)
c third leg of magnetic core (broken)
GB, GB′ bypass air gap
GM, GM′ main air gap
L1 first coil
L2 second coil
T1 first terminal
T2 second terminal
S1 first section
S2 second section
P1, P1′ first sub path
P2, P2′ second sub path
F1, F2 magnetic flux generated by coil
FM, FM′ magnetic flux generated by permanent magnet
FB, FB′ magnetic flux over bypass
RL load
ST, ST′ stepping
TA tapering
UG grid voltage source
AF arc flash
L inductivity
I current
Bmax maximum magnetic flux density

1. A device for limiting or reducing a current rise, comprising:
a first magnetic core with at least one annular path for a magnetic flux;
a first magnet arrangement having at least one permanent magnet in the at least one annular path of the first magnetic core; and,
a first coil being wound around the first magnetic core, wherein
the at least one annular path has a first section with parallel sub paths, wherein a first sub path of the sub paths comprises a first bypass air gap and a second sub path of the sub paths is a continuous path comprising said first magnet arrangement,
wherein the first magnetic core has two interconnected annular paths for a magnetic flux formed by three legs and interconnections of first ends of the three legs and interconnections of second ends of the legs, wherein
the first magnetic core comprises a main air gap, which is arranged in a third leg of the legs.

2. The device as claimed in claim 1, wherein
a first leg of the legs comprises the first section with the parallel sub paths, wherein
a second leg of the legs comprises a second section with parallel sub paths, wherein a third sub path of the sub paths comprises a second bypass air gap and a fourth sub path of the sub paths is a continuous path comprising a second magnet arrangement having at least one permanent magnet, wherein
the first coil is wound around the third leg and wherein
the first magnet arrangement and the second magnet arrangement cause a magnetic flux in the same rotational sense.

3. The device as claimed in claim 1, wherein
in the first section the first sub path is straight, and the second sub path dodges does not overlap the first sub path; and/or,
in the second section the first sub path is straight and the second sub path dodges does not overlap the first sub path.

4. The device as claimed in claim 3, wherein
in the first section the second sub path comprises a first part being arranged perpendicular to the first straight sub path, a second part adjacent to the first part being arranged parallel to the first straight sub path and a third part adjacent to the second part being arranged perpendicular to the first straight sub path; and/or,
in the second section the second sub path comprises a first part being arranged perpendicular to the first straight sub path, a second part adjacent to the first part being arranged parallel to the first straight sub path and a third part adjacent to the second part being arranged perpendicular to the first straight sub path.

5. The device as claimed in claim 4, wherein
in the first section each of the three parts consists of a permanent magnet; and/or,
in the second section each of the three parts consists of a permanent magnet.

6. The device as claimed in claim 4, wherein
in the first section the first part and the third part each consists of a permanent magnet and the second part is part of the first magnetic core; and/or,
in the second section the first part and the third part each consists of a permanent magnet and the second part is part of the magnetic core.

7. The device as claimed in claim 4, wherein
in the first section the first part and the third part each is part of the first magnetic core and the second part consists of a permanent magnet; and/or,
in the second section the first part and the third part each are part of the magnetic core and the second part consists of a permanent magnet.

8. the device as claimed in claim 4, wherein
a length of the first bypass air gap is smaller than a total length of parts in the first section consisting of a permanent magnet each measured in a direction of the magnetic flux; and/or,
a length of the second bypass air gap is smaller than a total length of parts in the second section consisting of a permanent magnet each measured in a direction of the magnetic flux.

9. The device as claimed in claim 1, wherein the first magnetic core adjacent to the main air gap comprises a stepping or a tapering.

10. The device as claimed in claim 1, wherein the first coil is arranged proximate the main air gap.

11. The device as claimed in claim 1, wherein
the permanent magnet or permanent magnets of the first magnet arrangement is/are made of Neodymium; and/or,
the first magnetic core is made of soft iron or Vanadium permendur.

12. An arrangement, comprising a device according to claim 1 and a switching device being switched in series with the first coil or the coil arrangement of said device.

13. An electric circuit being in the arrangement according to claim 12, and the electric circuit being connected to a DC grid.
